(19) United States
(12) Patent Application Publication
(10) Pub. No.: US 2026/0172368 A1
(43) Pub. Date: Jun. 18, 2026

(54) ADAPTIVE SCHEDULING FOR REAL-TIME COMMUNICATION NETWORKS

(71) Applicant: SKYWORKS SOLUTIONS, INC., Irvine, CA (US)

(72) Inventor: Samuel F. Hishmeh, Nolensville, TN (US)

(21) Appl. No.: 19/416,238

(22) Filed: Dec. 11, 2025

Related U.S. Application Data
(60) Provisional application No. 63/733,810, filed on Dec. 13, 2024.

(51) Int. Cl. H04L 47/50

(52) U.S. Cl. CPC H04L 47/50

(57) ABSTRACT

A method of scheduling transactions on a network is provided, including: determining one or more stream definitions based on one or more devices connected to the network; determining a schedule based on the one or more stream definitions; selecting from among a plurality of timing configurations a timing configuration based on the schedule; and controlling the one or more devices to use network resources according to the timing configuration.

### CROSS-REFERENCE TO RELATED APPLICATIONS

This Application claims priority under 35 U.S.C. § 119(e) to U.S. Provisional Application No. 63/733,810, titled ADAPTIVE SCHEDULING FOR REAL-TIME COMMUNICATION NETWORKS, filed on Dec. 13, 2024, which is hereby incorporated by reference in its entirety for all purposes.

### BACKGROUND

### 1. Field of the Disclosure

At least one example in accordance with the present disclosure relates generally to methods for scheduling data transmission in networks.

### 2. Discussion of Related Art

In various kinds of communication networks, such as wireless and/or wired communication networks (e.g., WiFi networks, Bluetooth™ networks, serial networks, and so forth), the transmission of data may be scheduled so that each device connected to the network can reliably send data over the network (e.g., through network switches, access points, and similar devices). The aspects of this disclosure may be applied to any communication network that can benefit from the scheduling of data transmissions and/or communications generally.

### SUMMARY

According to at least one aspect of the present disclosure, a method of scheduling transactions on a network is presented, comprising: determining one or more stream definitions based on one or more devices connected to the network; determining a schedule based on the one or more stream definitions; selecting from among a plurality of timing configurations a timing configuration based on the schedule; and controlling the one or more devices to use network resources according to the timing configuration.

According to at least one aspect of the present disclosure, a system is presented, comprising: an arbiter configured to schedule one or more transaction on a network; a transceiver; and one or more devices belonging to the network and communicatively coupled to the arbiter and the transceiver, the arbiter being further configured to: determine one or more stream definitions based on the one or more devices, determine a schedule based on the one or more stream definitions, select a timing configuration based on the schedule from among one or more timing configurations, and control the one or more devices to use network resources according to the timing configuration.

According to at least one aspect of the present disclosure, a non-transitory computer-readable media is presented, containing thereon instructions for scheduling transactions on a network, the instructions instructing at least one processor to: determine one or more stream definitions based on one or more devices connected to the network; determine a schedule based on the one or more stream definitions; select from among a plurality of timing configurations a timing configuration based on the schedule; and control the one or more devices to use network resources according to the timing configuration.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates a network according to an example;

FIG. 2 illustrates a schedule according to an example; and

FIG. 3 illustrates a process for scheduling transactions on a network according to an example.

### DETAILED DESCRIPTION

Communication networks are networks that facilitate the transfer of data from one device to another device. Communication networks may be wired, wireless, or both. Familiar communication networks include the internet, telephone networks, home router networks, and various devices that rely on a given communication protocol (such as Bluetooth™ enabled devices), and so forth. Less familiar examples of communication networks may include GPS systems, fly-by-wire systems, and so forth.

Most communication networks include one or more terminal devices that are the ultimate creators and receivers of communications over the network. These terminal devices typically access the network through access points, which are devices or connections that permit the terminal device to use the network. Many networks additionally include switching devices or network switches which are designed to route traffic through the network from device to device, access point to access point, network switch to network switch, and so forth. These components thus permit devices to communicate with one another by ensuring that a given message is routed from an originating device to the intended recipient device.

Such networks can be quite complicated. In the example of the internet, the internet includes numerous interconnected networks that are linked by switching devices, and a vast array of terminal devices, many of which use different communication protocols compared to each other. Substantial additional infrastructure is also used to maintain the internet, such as DNS servers. A given network switch on the internet may, as a result, receive hundreds or more of connection requests at a given time that require data to be routed from one device to another device. However, many network switches are serial transmitters, meaning they can transmit only a single communication along a given network link (here, the network link representing a link between the network switch and another device). Even if a network switch is capable of outputting multiple network links simultaneously, each link is generally only able to contain one discrete communication—a discrete communication being a communication from one device intended for another device.

As a result, in the foregoing example of the internet, if one device is allowed to dominate a given network switch, other devices on the network may not be able to transmit data on the network. Therefore, network communications may be scheduled such that different devices are permitted to use a given network resource (such as a network switch) only during a predetermined time interval.

When devices are permitted to use certain network resources only during a given time interval, this is called scheduling. In a scheduled network (not necessarily the internet, as some protocols used to facilitate internet communications are not scheduled, the internet being used above as a convenient and familiar example of a network), devices are assigned intervals of time by an arbiter or scheduler (sometimes also referred to as a supervisor or master device) during which the arbiter permits use of the network by said devices.

For example, there may be two devices on a network, devices A and B. The arbiter (which may be a network switch, but may also and/or instead be one or more controllers, such as processors, microprocessors, ASICs, FPGAs, and so forth, programmed to handle scheduling) may then create two time slots, a first slot and a second slot. Device A may be permitted to use the network during the first slot, and device B may be permitted to use the network during the second slot, thereby ensuring that the devices do not interfere with each other. In some examples, the arbiter (or another device) may include a cache (e.g., memory) to store data for use during an appropriate time slot. For example, the scheduling may permit a device to transmit data at any time, but only to receive data during the allocated slot. Therefore, another device may be configured to receive communications during several time slots, and then to forward those communications only during an appropriate time slot.

Most networks also have bandwidth limitations. For the purpose of this application, bandwidth may be thought of as the overall throughput of the network or of a given channel of communication within the network (e.g., one connection—one channel—may have higher bandwidth than another). The important point is that bandwidth will typically be a finite resource that represents a cap on the amount of data it is possible to transmit over a given period of time.

Because bandwidth is limited, and because demands for network resources (and therefore bandwidth) may vary over time, the scheduling requirements of a scheduled network may change over time. When relatively few devices are using the network, the timing constraints for the devices may be relatively generous, and more than enough time to serve each device may be available. By contrast, when a relatively large number of devices are connected to the network, the timing constraints may be more severe and it may be more difficult to meet said constraints as there may not be enough time available to serve each device.

Aspects of this disclosure relate to a universal and general method of scheduling traffic on a network where the requirements of the devices on the network may be known before the schedule is decided (for example, as is the case with many real-time data streams such as audio data, video data, game controller data, and so forth). In one example, the network may include one or more devices, an arbiter, and a radio—the radio being any type of wireless transmitter. In other examples, a wired connection may replace the radio. In still other examples, both radio and wired connections may be used together. However, the methods and systems described herein apply equally to radios as well as other types of wireless or wired connection, and thus reference will be made to radio for convenience, but should be understood to refer to any type of connection.

In some examples, the arbiter receives requests for network resources (e.g., bandwidth) from devices and then determines how the network resources are to be allocated. Once the determination is made, the arbiter may provide an order to the radio indicating the decided upon allocation of resources. The radio may then determine a timing configuration that meets the requirements of the order and transmit data according to that configuration. The radio may also be implemented such that it has functionality for handling skipped transmissions (or for skipping and/or throttling transmissions when resource demands exceed the throughput of the radio).

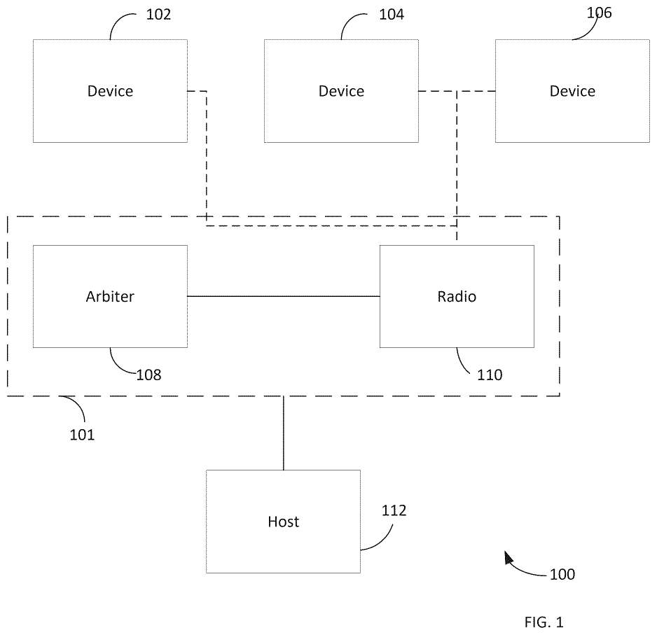

FIG. 1 illustrates a network 100 according to an example. The network 100 may implement a method of scheduling as described herein. The network 100 includes a first device 102, a second device 104, a third device 106, an arbiter 108, a radio 110, and a host device 112 (“host 112”). In some examples, the network 100 may include a radio device 101, wherein the radio device 101 may include both the arbiter 102 and the radio 110. The radio device 101 may be any type of electronic device, for example, a computer system, a communications microcontroller, and so forth.

The first device 102, second device 104, and third device 106 are communicatively coupled to the radio 110. The arbiter 108 is coupled to the radio 110. The radio device 101 is coupled to the host 112 (e.g., via USB or UART or another connection). The host 112 may be coupled directly to the arbiter 108.

The devices 102, 104, 106 may request network resources, for example, by providing their requirements or a range of requirements (e.g., minimum requirements, preferred requirements, and so forth) to the arbiter 108 and/or to the host 112. The host 112 may use the requirements to determine the different streams, and then relay the determined streams to the arbiter 108.

The arbiter 108 may receive said requirements and determine a preferred schedule for communications by the device 102, 104, 106 on the network. The arbiter 108 may select an appropriate timing configuration that meets the requirements of the schedule, or comes closest to meeting the requirements of the schedule, or inform the arbiter 108 that the requirements cannot be met. The radio 110, under control/management by the arbiter 108, may then facilitate communications between the devices 102, 104, 106 (e.g., each other) as well as with or between other devices.

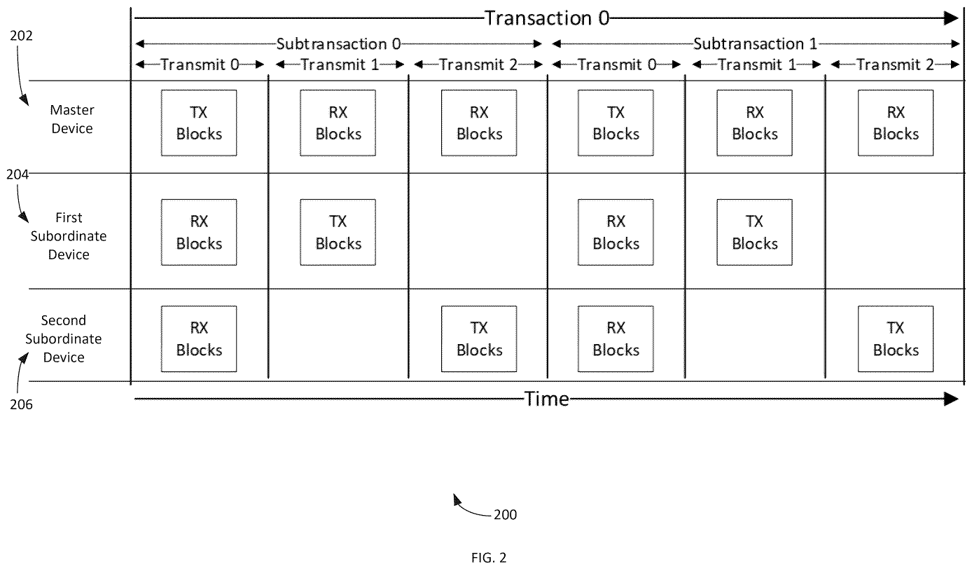

FIG. 2 illustrates a hypothetical schedule 200 for a network with two devices according to an example. The schedule 200 has three rows, a first row 202, a second row 204, and a third row 206. The schedule is further divided into six columns, labeled “Transmit 0,” “Transmit 1,” and “Transmit 2.” These six columns are in turn divided into a first subtransaction and a second subtransaction, labeled “Substransaction 0” and “Subtransaction 1,” covering the first three columns and the second three columns, respectively. Both subtransactions are further classified as belonging to “Transaction 0,” which covers all of the columns.

This schedule corresponds to a Time Division Multiple Access (TDMA) network. The term “transaction,” as in “Transaction 0,” refers to the communication interval of the network. The communication interval of the network is simply a period of time that may be determined automatically, dynamically, or may be predetermined or preset. A transaction may have indefinite length. For example, a transaction may begin with activation of the system and continue until deactivation of the system. A “subtransaction” as used herein refers to a transmission cycle, where the transmission cycle may, in some examples, be a cycle during which each device on the network is permitted to transmit at least once. In some examples, a subtransaction may instead apply not to each device on the network, but to a subset of the devices on the network. In some examples, within each transaction, each subtransaction may be identical (e.g., the data transmitted may be the same for each subtransaction belonging to a given transaction). The term “transmit” as used with respect to FIG. 2, for example, “Transmit 0,” refers to a period of time during which a single block of data is transmitted. A block of data is simply a collection of data (usually represented using bits) in the network that are intended to be transmitted as a unit. The blocks may have a set size, a predetermined size, variable sizes, and so forth.

The first row 202 corresponds to the state of a master device, such as the arbiter 108 of FIG. 1. The second row 204 corresponds to a first subordinate device, such as the first subordinate device 102, and the third row 206 corresponds to a second subordinate device, such as the second subordinate device 104 of FIG. 1.

The columns each have an entry corresponding to one of the rows 202, 204, 206. These entries indicate a state of the device corresponding to said row at a given time. As illustrated, the six entries for the first row 202 are, from left-to-right, TX blocks, RX blocks, RX blocks, TX blocks, RX blocks, RX blocks. These entries indicate that the master device (e.g., arbiter 108) is transmitting data to some or all subordinate devices during the Transmit 0 period of each subtransaction and is receiving data from a subordinate device during the Transmit 1 and Transmit 2 periods of each subtransaction. In other words, “TX Blocks” refers to a state where the corresponding device of the row 202, 204, 206 is transmitting data, and “RX blocks” refers to the state where the corresponding device is receiving data.

The entries of the second row 204 are, from left-to-right, RX blocks, TX blocks, nothing (the entry is empty), RX blocks, TX blocks, and nothing. These indicate that the first subordinate device is receiving data during the transmit 0 of each subtransaction, and is transmitting data during the transmit 1 of each subtransaction. The first subordinate device is neither transmitting nor receiving during the transmit 2 of each subtransaction.

The entries of the third row 206 are, from left-to-right, RX blocks, nothing, TX blocks, RX blocks, nothing, TX blocks. Thus, the second subordinate device is receiving during the transmit 0 and transmitting during the transmit 2 of each subtransaction, and neither transmitting nor receiving during the transmit 1 of each subtransaction.

Accordingly, FIG. 2 illustrates a schedule where the master devices sends data during “Transmit 0,” and both subordinate devices receive data during that same time period. Then the master device receives data for the rest of the subtransaction (e.g., the master device is listening for communications from one or more subordinate devices or other devices). Each subordinate device takes a turn, during the subtransaction, to send data out (e.g., to send data to the master device), with the first subordinate device doing so before the second subordinate device. In this way, each device on the network knows when it will receive data and when it can send data, and thus the network can be managed.

Returning now to FIG. 1, in some examples the arbiter 108 cannot generate a reasonable schedule for the system unless the arbiter 108 knows the devices on the network, the direction of data on the network, the number of times the data should be sent (e.g., the number of subtransactions), and the number of blocks being sent or received per transaction and/or transmission. To accomplish this, the network may use streams.

As used herein, a stream contains at least the following information: the source of a data transmission, the destination of the data transmission, the number of subtransactions (e.g., the number of times to send data), and the number of blocks (of data) to be sent or received per transaction. A stream may be defined for each device on the network, or for each unique combination of source and destination on the network. For example, a stream may be configured to be sent from one device to another device or from one device to multiple devices. Note that, in some examples, the source-destination pair (or a member thereof) must have predetermined the number of blocks and subtransactions (and indeed, the source and destination) prior to creating the stream definition.

The streams, as can be inferred from the above definition, contain sufficient information to determine the scheduling requirements associated with a given transmission corresponding to the source-destination pair of the stream. Thus, the arbiter 108 may use the stream definitions to schedule traffic on the network. In some examples, the routing of a block from source to destination may pass through other devices (such as the arbiter 108 itself, and/or the radio 110), and the arbiter 108 must account for the effect of this sort of relaying when determining the schedule.

From time-to-time, a stream may be redefined. For example, a device may disconnect from the network, a given device may simply need to transmit more or less data compared to before, or a given device may need to receive more or less data compared to earlier. In these circumstances, redefining the stream is a way to inform the arbiter 108 of the change in requirements, and thus to allow the arbiter 108 to generate a new schedule.

However, the radio 110 must be able to accommodate the new schedule. For this reason, the radio 110 may be preprogrammed with various configurations and may have internal logic that permits it to select from among the configurations to use the configuration that best meets the requirements of the schedule from the arbiter 108.

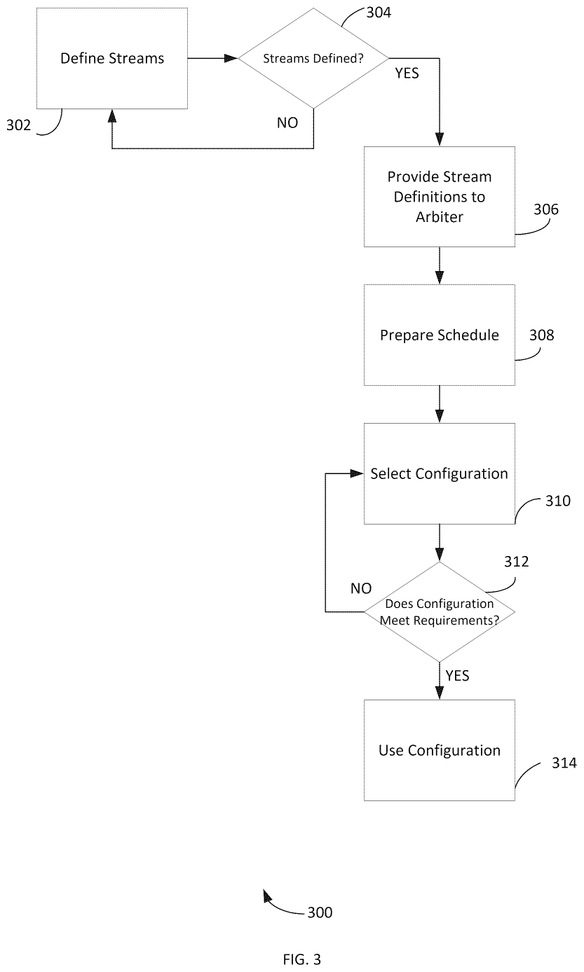

Turning now to FIG. 3, FIG. 3 illustrates a process 300 of how a transmitter and/or receiver device (such as a radio or the arbiter 108 and/or radio 110 of FIG. 1) may select from among one or more timing configurations corresponding to one or more schedules.

At act 302, the streams that will be used to make the schedule will be defined. The host device (e.g., host 112 of FIG. 1) may define the streams. These streams may be generated by the devices on the network working alone or in tandem. The process 300 may then continue to act 304.

At act 304, the network checks whether all streams have been defined. The network may do this as a tandem effort by the devices on the network, or it may be done by a particular device on the network, such as the host 112 and/or arbiter 108. If all of the streams have been defined (304 YES), the process 300 may continue to act 306. If all the streams have not been defined (304 NO), the process 300 may return to act 302 to define further streams.

At act 306, the arbiter (or a similar controller or master device) receives and/or finishes generating the stream definitions. The process 300 then continues to act 308.

At act 308, the arbiter prepares a schedule based on the streams. The arbiter may compare the information provided in the stream definitions to determine a desired level of performance or a desired set of timings for communications. For example, if there are four devices that defined streams, the arbiter may determine when each of those devices may use network resource (for example, transmit on the network) and/or when the arbiter or other devices should listen for transmissions from those devices, and/or when the arbiter will be using the network resources, and so forth. The arbiter may also determine a schedule by which the schedule may be updated, if desired. Alternatively, the arbiter may update the schedule on demand. In some examples, in addition to or in lieu of determining when a device may use network resources, the arbiter may generate a schedule based on when a particular stream may be active. That is, if device A is communicating with devices B and C, but device B is not communicating with device C, then device A may require more transactions, subtransactions, or blocks to effectively receive and/or transmit to devices B and C, while devices B and C may require relatively fewer resources. Instead or in addition to scheduling this based on the devices, the arbiter may schedule based on the streams, for example, by assigning time intervals (transactions, subtransactions, blocks, etc.) not directly to a given device but instead to a given stream (even though this does, ultimately, translate into assigning time intervals based on devices). Once the schedule is prepared, the process 300 may continue to act 310.

At act 310, arbiter and/or transceiver select a first configuration from among a plurality of configurations to serve the schedule. This configuration may include a determination of the number of transactions, the number of subtransactions per transaction, the number of blocks per subtransaction, and so forth. As discussed above, there may be only one transaction of indefinite length (e.g., from activation to deactivation of the system). In some examples, only a subset of the number of transactions, subtransactions, and/or blocks may be relevant. For example, the number of transactions may not matter, only the number of subtransactions and/or the number of blocks per subtransaction may matter when determining/selecting and/or evaluating (as in act 312) a configuration. Once a configuration is selected, the process 300 may then continue to act 312.

At act 312, the transceiver and/or the arbiter check whether the selected configuration meets the needs of the schedule. For example, a configuration may not provide enough transactions, subtransactions, or blocks to meet the minimum requirements of a given device. If the configuration meets the requirements of the schedule (312 YES), the process 300 continues to act 314. If the configuration does not meet the requirements of the schedule (312 NO), the process 300 may return to act 310.

In the case where the configuration does not meet the requirements of the schedule (312 NO), the transceiver and/or arbiter may select a different configuration than the configuration previously selected at act 310. The previously selected configuration may also be removed from the set of selectable configurations in the future (thereby eliminating it from contention until a new schedule is generated). Then the process 300 may return to act 312 and repeat these acts 310, 312 until a configuration that meets the schedule's requirements is selected.

In the case that the configuration does meet the requirements of the schedule (312 YES), the transceiver and/or arbiter may use the selected configuration until a new schedule is generated. When a new schedule is generated, for example, due to a change in a stream definition, the creation or removal of a stream, and so forth, the process 300 may start again from act 302 or act 306 to determine a new configuration.

In some cases, there may be no configuration that can meet the requirements of the schedule. In such a case, the transceiver may alert the arbiter that the schedule must be changed and a new schedule may be generated.

The transceiver and/or arbiter may sort through the configurations using various methods. In one example, the configurations may be cycled through by beginning with the configuration having the highest transaction time and/or bandwidth usage, and then moving down the list of configurations one at a time with each next configuration having a lower transaction time than the one preceding it. Other searches are also possible. For example, the transceiver and/or arbiter may use a binary search to shuffle through configurations. Any type of search can be used, though some searches may be more or less efficient than others in terms of time, computational resources, and so forth.

In some examples, the transceiver and/or arbiter may take additional steps once a viable schedule is found. For example, once a minimum number of blocks per transaction or subtransaction is determined and a corresponding schedule created and/or configuration set, the schedule may be iterated so that a configuration can be found that maximizes the number of blocks per transactions and/or subtransaction. This may be repeated so that each stream receives the maximum number of blocks possible.

In some examples, the network may include devices that need to use network resources infrequently. Such devices may only need to transmit data once every few milliseconds, seconds, minutes, and so forth. Note that the term “infrequently” is relative and will depend on other factors, such as the communication speed of other devices or an average communication frequency on the network. Thus, a millisecond may be a long delay when communications are handled every microsecond or nanosecond, but would be an irrelevant delay when communications are handled every millisecond or second, and so forth. Devices that use network resources infrequently may include, but are not limited to, temperature sensors, battery packs, and so on.

In the case of less resource-needy devices, the arbiter (e.g., arbiter 108) may adapt the schedule to accommodate these devices that only infrequently use the network's resources. In one example, the arbiter may create a subtransaction or a transaction that includes time allocated for such devices. Each such device may then be assigned a sequential time interval (e.g., a sequential “transmit” as described with respect to FIG. 2) or a sequential subtransaction during which that device transmits. Thus, in some examples, each “infrequent” device may transmit during the same subtransaction. This may be accomplished, in at least one example, by overloading the subtransaction stream parameter to be a negative number that corresponds to the interval between which the device uses the network's resources. In some examples, the interval may be measured in transactions or subtransactions.

In some examples, to simplify determination of the schedule and selection of a configuration, the arbiter and/or transceiver may use a minimum number of blocks, subtransactions, and/or transactions for the most demanding device as the baseline for all streams and/or devices. For example, suppose device A requires three subtransactions each having two blocks, and device B requires two subtransactions each having three blocks. Then the arbiter and/or transceiver would assume that each device requires three subtransactions (the largest number of subtransactions across the two devices) and three blocks per subtransaction (the largest number of blocks per subtransaction across the two devices). This ensures that each device has at least the minimum number of subtransactions and blocks it requires. To put it another way, there is not necessarily any detriment for a device that needs two blocks to have three blocks (e.g., to have an extra block). Of course, the arbiter and/or transceiver need not simplify scheduling and configuration selection in this way. For example, if network resources are tight, it may be preferable to spend additional time determining the schedule and configuration to more exactly conform to the minimum requirements of each device, thereby freeing up subtransactions and/or blocks for other devices on the network.

In some examples, devices that use network resources infrequently may interrupt real-time streams. For example, two devices may be communicating in real-time with one another, and that connection would be interrupted if a low frequency device suddenly transmitted. In such cases, the arbiter and/or transceiver may reserve a time slot (e.g., one or more subtransactions) within a transaction during which low frequency devices may use network resources, to minimize or eliminate interruption to real-time streams. The time slots allocated in this way may be used by other devices when the low frequency devices are not using them.

In another example, devices that are low frequency, and/or other devices, may skip a number of transactions that are not multiples of one another. For example, device A may only need to use network resources once every two transactions, while device B may only need to use network resources once every three transactions. In such cases, the arbiter and/or transceiver may have each device skip a number of transactions equal to the fewest skipped transactions. For example, even though device B only needs to transmit every three transactions, the arbiter and/or transceiver may instead permit device B to transmit every two transactions, which is more often than the minimum frequency device B requires, and therefore meets (and exceeds) device B's minimum requirements.

Examples of the methods and systems discussed herein are not limited in application to the details of construction and the arrangement of components set forth in the description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Various controllers, such as the arbiter and/or host and/or radio, may execute various operations discussed above. Using data stored in associated memory and/or storage, the controllers also execute one or more instructions stored on one or more non-transitory computer-readable media, which the controllers may include and/or be coupled to, that may result in manipulated data. In some examples, the controllers may include one or more processors or other types of controllers. In one example, the controllers are or includes at least one processor. In another example, the controllers perform at least a portion of the operations discussed above using an application-specific integrated circuit tailored to perform particular operations in addition to, or in lieu of, a general-purpose processor. As illustrated by these examples, examples in accordance with the present disclosure may perform the operations described herein using many specific combinations of hardware and software and the disclosure is not limited to any particular combination of hardware and software components. Examples of the disclosure may include a computer-program product configured to execute methods, processes, and/or operations discussed above. The computer-program product may be, or include, one or more controllers and/or processors configured to execute instructions to perform methods, processes, and/or operations discussed above.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A method of scheduling transactions on a network, comprising:
determining one or more stream definitions based on one or more devices connected to the network;
determining a schedule based on the one or more stream definitions;
selecting from among a plurality of timing configurations a timing configuration based on the schedule; and
controlling the one or more devices to use network resources according to the timing configuration.

2. The method of claim 1 wherein each stream definition includes a source ID of a source device of the one or more devices, a destination ID of a destination device of the one or more devices, a number of subtransactions, and a minimum number of blocks per transaction.

3. The method of claim 2 wherein the number of subtransactions is based on a number of times data should be sent during a transaction.

4. The method of claim 2 wherein each stream definition includes a maximum number of blocks per transaction.

5. The method of claim 1 further comprising determining timing characteristics of a transceiver, the transceiver being used to facilitate communications between the one or more devices and an arbiter of the network.

6. The method of claim 1 wherein the schedule is divided into one or more transactions, each transaction of the one or more transactions having one or more subtransactions, and each subtransaction of the one or more subtransactions having one or more blocks.

7. The method of claim 6 wherein a block of the one or more blocks is a unit of data being transmitted or received over an interval of time corresponding to a length of a subtransaction of the one or more subtransactions.

8. The method of claim 1 further comprising:
determining whether the timing configuration meets one or more requirements of the schedule; and
selecting a different timing configuration responsive to determining that the timing configuration does not meet one or more requirements of the schedule.

9. The method of claim 8 wherein the different timing configuration is selected by selecting a configuration from among one or more timing configurations that has a next highest transaction time compared to the timing configuration.

10. The method of claim 1 further comprising:
identifying one or more low frequency devices of the one or more devices, the one or more low frequency devices being devices that transmit relatively infrequently compared to other devices of the one or more devices; and
scheduling a special transaction or a special subtransaction during which each of the one or more low frequency devices may use the network resources.

11. The method of claim 9 wherein the special transaction or the special subtransaction is scheduled to occur at a frequency corresponding to a highest frequency device of the one or more low frequency devices, wherein the highest frequency device is a device that uses network resources most often of the one or more low frequency devices.

12. A system comprising:
an arbiter configured to schedule one or more transaction on a network;
a transceiver; and
one or more devices belonging to the network and communicatively coupled to the arbiter and the transceiver, the arbiter being further configured to:
determine one or more stream definitions based on the one or more devices,
determine a schedule based on the one or more stream definitions,
select a timing configuration based on the schedule from among one or more timing configurations, and
control the one or more devices to use network resources according to the timing configuration.

13. The system of claim 12 wherein each stream definition includes a source ID of a source device of the one or more devices, a destination ID of a destination device of the one or more devices, a number of subtransactions, and a minimum number of blocks per transaction.

14. The system of claim 13 wherein the number of subtransactions is based on a number of times data should be sent during a transaction.

15. The system of claim 12 wherein the transceiver is a radio.

16. The system of claim 12 wherein the arbiter is coupled to the transceiver and configured to determine timing characteristics of the transceiver, and wherein communications on the network between the one or more devices are routed through at least the transceiver.

17. The system of claim 12 wherein the arbiter divides the schedule into one or more transactions, each transaction of the one or more transactions having one or more subtransactions, and each subtransaction of the one or more subtransactions having one or more blocks.

18. The system of claim 17 wherein a block of the one or more blocks is a unit of data being transmitted or received over an interval of time corresponding to a length of a subtransaction of the one or more subtransactions.

19. The system of claim 12 wherein the arbiter is further configured to:
determine whether the timing configuration meets one or more requirements of the schedule; and
select a different timing configuration responsive to determining that the timing configuration does not meet one or more requirements of the schedule.

20. A non-transitory computer-readable media containing thereon instructions for scheduling transactions on a network, the instructions instructing at least one processor to:
determine one or more stream definitions based on one or more devices connected to the network;
determine a schedule based on the one or more stream definitions;
select from among a plurality of timing configurations a timing configuration based on the schedule; and
control the one or more devices to use network resources according to the timing configuration.
